(19) United States
(12) Patent Application Publication
(10) Pub. No.: US 2012/0251365 A1
(43) Pub. Date: Oct. 4, 2012

(54) HIGH PRESSURE FUEL PUMP

(75) Inventor: Toshihide ONO, Chita-gun (JP)

(73) Assignee: DENSO CORPORATION, Kariya-city (JP)

(21) Appl. No.: 13/432,110

(22) Filed: Mar. 28, 2012

(30) Foreign Application Priority Data
Mar. 30, 2011 (JP) 2011-75370

(51) Int. Cl. F02M 37/04

(52) U.S. Cl. 417/440

(57) ABSTRACT

A discharge valve body and a relief valve body are coaxially arranged in-series in a discharge-relief valve unit, which is accommodated in a fuel discharge passage. When a first forward force acting on the discharge valve body in its valve opening direction becomes larger than a second rearward force acting on the same valve body in a valve closing direction, the discharge valve body is moved in its valve closing direction, so that fuel is pumped out from a fuel pressurizing chamber to a discharge port. When a second forward force acting on the relief valve body in a valve opening direction becomes larger than a first rearward force acting on the same valve body in its valve closing direction, the relief valve body is moved in its valve opening direction, so that a fuel relief is allowed from a discharge-port side to a pressurizing-chamber side.

### CROSS REFERENCE TO RELATED APPLICATION

This application is based on Japanese Patent Application No. 2011-075370 filed on Mar. 30, 2011, the disclosure of which is incorporated herein by reference.

### TECHNICAL FIELD

The present disclosure relates to a high pressure fuel pump for an internal combustion engine.

### BACKGROUND

A fuel supply apparatus for supplying fuel to an internal combustion engine is generally composed of; a high pressure fuel pump for pumping out high pressure fuel; a fuel common rail for accumulating the high pressure fuel from the high pressure fuel pump; fuel injectors connected to the fuel common rail for injecting the high pressure fuel into respective cylinders of the engine; and so on. A following situation may happen in the high pressure fuel pump, in which the fuel pressure in the fuel common rail will be increased to an abnormal high pressure beyond a permissible zone, if a suction valve or a discharge valve may become out of order or temperature may become excessively high. It is known in the art that a relief valve is provided in the high pressure fuel pump in order that excessive fuel above a predetermined relief pressure escapes into a return passage. As a result, a breakage of the fuel injectors may be avoided.

According to a high pressure fuel pump, for example, as disclosed in Japanese Patent Publication No. 2004-138062, a fuel discharge passage for discharging fuel from a fuel pressurizing chamber to a fuel discharge port via a discharge valve and a fuel relief passage for returning excessive fuel beyond a predetermined fuel pressure from a fuel common rail back to the fuel pressurizing chamber via a relief valve are provided in parallel to each other. According to the above structure of the prior art, when the fuel is pumped out, the fuel pressure of the fuel pressurizing chamber acts on not only the fuel discharge valve in its valve opening direction but also the fuel relief valve in a direction to its valve seat portion. Therefore, even when the fuel pressure of the fuel pressurizing chamber becomes higher than a relief valve opening pressure during the fuel pump-out operation, the relief valve will not be opened. Accordingly, such a situation that a part of the pump-out fuel may flow out via the relief valve can be avoided to increase control accuracy for adjusting a flow rate of the fuel.

According to the high pressure fuel pump of the above prior art (JP No. 2004-138062), a cylindrical bore for the fuel discharge valve and a cylindrical bore for the fuel relief valve are respectively formed in a pump housing, to thereby increase a number of portions for which a high-pressure seal is necessary.

According to a high pressure fuel pump of another prior art, for example, as disclosed in U.S. Pat. No. 7,401,593, a large chamber is formed in a pump housing and a small bore for the fuel discharge valve and a small bore for the fuel relief valve are formed at a bottom of such large chamber. Then, a connector is fixed to the large chamber so as to reduce the number for the high-pressure sealing portions.

According to a high pressure fuel pump of a further prior art, for example, as disclosed in Japanese Patent Publication No. 2010-174903, when a relief valve is opened, fuel flows not to a fuel pressurizing chamber but to a low-pressure side. When the fuel is pumped out, a fuel relief passage connected to the relief valve is closed depending on a lift amount of a fuel discharge valve. According to a structure of this prior art, it is possible to avoid such a situation according to which the fuel relief valve is opened and thereby a part of pumped-out fuel flows out, when the fuel pressure in the fuel pressurizing chamber becomes higher than a relief valve opening pressure. The control accuracy for adjusting the flow rate of the fuel is improved.

As explained above, according to the high pressure fuel pumps of the above prior arts (JP No. 2004-138062 & U.S. Pat. No. 7,401,593), the fuel discharge passage and the fuel relief passage are arranged in parallel to each other, and both of the passages are connected to the fuel pressurizing chamber. In a fuel pressurizing stroke, not only the fuel in the fuel pressurizing chamber but also the fuel in the fuel discharge passage (that is, the fuel in a space between the fuel pressurizing chamber and the discharge valve) as well as the fuel in the fuel relief passage (that is, the fuel in a space between the fuel pressurizing chamber and the relief valve) are pressurized. In other words, so-called a dead volume, which corresponds to a volume of the fuel to be pressurized not in the fuel pressurizing chamber but in such spaces other than the fuel pressurizing chamber, will be increased according to the high pressure fuel pump of the above prior arts. Fuel discharge efficiency is thereby decreased.

According to the structure of the high pressure pump of the prior art (JP No. 2010-174903), the dead volume is not increased. However, the structure of the fuel discharge valve is complicated and it requires a high accuracy for manufacturing processes. Therefore, manufacturing cost will be increased.

In addition, according to the high pressure fuel pump of any one of the above prior arts, the fuel discharge valve and the fuel relief valve are provided in the respective fuel passages. In other words, it is necessary to form respective bores (valve accommodating portions) in a pump housing and to assemble the respective valves to the pump housing independently from each other. As a result, a size of the pump housing will become larger and the manufacturing cost will be increased.

### SUMMARY OF THE DISCLOSURE

The present disclosure is made in view of the above points. It is an object of the present disclosure to provide a high pressure fuel pump, a housing of which can be made smaller by simplifying a structure of a fuel discharge valve as well as a fuel relief valve to thereby reduce manufacturing cost of the fuel pump, and according to which fuel discharge efficiency can be increased by decreasing dead volume for a fuel pressurizing chamber.

According to a feature of the present disclosure, for example, as defined in the appended claim 1, a high pressure fuel pump has a plunger, a cylinder, a pump housing, a seat member, a discharge valve body, a relief valve body, a first biasing member and a second biasing member.

The cylinder movably accommodates the plunger so that the plunger is reciprocated in its axial direction.

The pump housing has; a fuel pressurizing chamber in which fuel is pressurized by a reciprocal movement of the plunger; a fuel discharge port from which high pressure fuel pressurized in the fuel pressurizing chamber is pumped out; and a fuel discharge passage communicating the fuel pressurizing chamber to the fuel discharge port;

The cylindrical seat member is provided in the fuel discharge passage and has a first seat portion on an axial end surface of a side to the fuel pressurizing chamber.

The discharge valve body is movably accommodated in a radial-inside space of the cylindrical seat member so that the discharge valve body is reciprocated therein in its axial direction.

The discharge valve body has;

a first pressure receiving portion at a first axial end thereof on a side to the fuel pressurizing chamber; a first contacting portion at the first axial end in a radial-outside area of the first pressure receiving portion; and

a second pressure receiving portion at a second axial end on a side to the fuel discharge port.

The relief valve body is movably provided in the fuel discharge passage on a side of the discharge valve body to the fuel pressurizing chamber.

The relief valve body has;

a communication passage facing to the first pressure receiving portion and communicating a space of the fuel discharge passage at a first axial end of the relief valve body on a side to the fuel pressurizing chamber with another space of the fuel discharge passage at a second axial end of the relief valve body on a side to the fuel discharge port;

a third pressure receiving portion at the first axial end of the relief valve body in a radial-outside area of the communication passage;

a second seat portion at the second axial end of the relief valve body in a radial-outside area of the communication passage, wherein the first contacting portion of the discharge valve body is operatively seated on the second seat portion; and

a second contacting portion at the second axial end of the relief valve body in a radial-outside area of the second seat portion, wherein the second contacting portion is operatively seated on the first seat portion of the cylindrical seat member.

The first biasing member biases the relief valve body in a direction toward the fuel discharge port.

The second biasing member biases the discharge valve body in a direction toward the fuel pressurizing chamber.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic cross sectional view showing a high pressure fuel pump according to a first embodiment of the present disclosure;

FIGS. 2A to 2C are schematic cross sectional views showing relevant portions of the high pressure fuel pump of the first embodiment, wherein FIG. 2A shows a valve closed condition of a fuel discharge valve and a fuel relief valve, FIG. 2B shows a valve opened condition of the fuel discharge valve, and FIG. 2C shows a valve opened condition of the fuel relief valve;

FIG. 3A is a schematic cross sectional view showing a fuel discharge-relief valve unit of the first embodiment, FIG. 3B is a schematic side view of the valve unit when viewed in a direction of an arrow III-B in FIG. 3A, and FIG. 3C is a schematic side view of the valve unit when viewed in a direction of an arrow III-C in FIG. 3A;

FIGS. 4A and 4B are schematically enlarged cross sectional views, respectively showing the valve opened conditions of the fuel discharge valve and the fuel relief valve, and FIG. 4C is a schematic side view of the fuel discharge valve when viewed in a direction of an arrow IV-C in FIG. 4A;

FIG. 5A is a schematically enlarged cross sectional view showing a valve closed condition of a fuel discharge valve and a fuel relief valve of a high pressure fuel pump according to a second embodiment of the present disclosure;

FIG. 5B is a schematically enlarged cross sectional view showing a valve closed condition of a fuel discharge valve and a fuel relief valve of a high pressure fuel pump according to a third embodiment of the present disclosure;

FIGS. 6A and 6B are schematically enlarged cross sectional views, respectively showing the valve opened conditions of the fuel discharge valve and the fuel relief valve according to the second embodiment, and FIG. 6C is a schematic side view of the fuel discharge valve when viewed in a direction of an arrow VI-C in FIG. 6A;

FIGS. 7A and 7B are schematically enlarged cross sectional views, respectively showing the valve opened conditions of the fuel discharge valve and the fuel relief valve according to the third embodiment, and FIG. 7C is a schematic side view of the fuel discharge valve when viewed in a direction of an arrow VII-C in FIG. 7A;

FIG. 8A is a schematically enlarged cross sectional view showing a valve closed condition of a fuel discharge valve and a fuel relief valve of a high pressure fuel pump according to a fourth embodiment of the present disclosure;

FIG. 8B is a schematically enlarged cross sectional view showing a valve closed condition of a fuel discharge valve and a fuel relief valve of a high pressure fuel pump according to a fifth embodiment of the present disclosure;

FIGS. 9A and 9B are schematically enlarged cross sectional views, respectively showing the valve opened conditions of the fuel discharge valve and the fuel relief valve according to the fourth embodiment, and FIG. 9C is a schematic side view of the fuel discharge valve when viewed in a direction of an arrow IX-C in FIG. 9A;

FIGS. 10A and 10B are schematically enlarged cross sectional views, respectively showing the valve opened conditions of the fuel discharge valve and the fuel relief valve according to the fifth embodiment, and FIG. 10C is a schematic side view of the fuel discharge valve when viewed in a direction of an arrow X-C in FIG. 10A;

FIG. 11 is a schematic cross sectional view showing a high pressure fuel pump according to a sixth embodiment of the present disclosure;

FIG. 12 is a schematic cross sectional view showing a fuel discharge-relief valve module of the sixth embodiment;

FIGS. 13A and 13B are schematically enlarged cross sectional views, respectively showing a relevant portion of a high pressure fuel pump according to a seventh and an eighth embodiment; and

FIGS. 14A to 14C are schematic views, respectively showing a relevant portion of a fuel discharge valve of a high pressure fuel pump according to further modifications.

### DETAILED DESCRIPTION OF THE EMBODIMENTS

The present disclosure will be explained by way of multiple embodiments with reference to the drawings. The same reference numerals are used throughout the embodiments for the purpose of designating the same or similar parts and/or components.

### First Embodiment

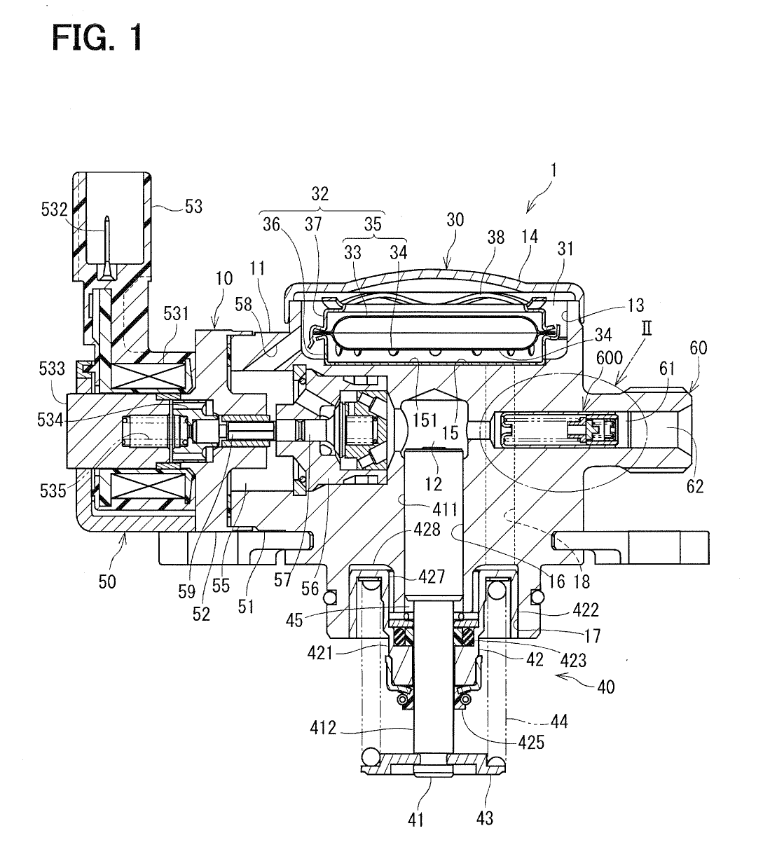

A high pressure fuel pump according to a first embodiment of the present disclosure will be explained with reference to FIGS. 1 to 4.

The high pressure fuel pump 1 (hereinafter, the fuel pump 1) is mounted in an automotive vehicle for pressurizing fuel supplied from a fuel tank by a low-pressure fuel-feed pump and supplying such pressurized fuel to a fuel common rail to be connected to fuel injectors mounted in an internal combustion engine (for example, a diesel engine). Although not shown, a fuel inlet port of the fuel pump 1 is connected to a fuel pipe, in which the low-pressure fuel-feed pump is provided at an upstream side of the fuel pump 1.

In the drawings, an upper side of the drawing corresponds to an upper portion of the fuel pump 1 in a vertical direction, while a lower side corresponds to a lower portion thereof.

As shown in FIG. 1, the fuel pump 1 is composed of; a main body portion 10; a fuel supply portion 30; a plunger portion 40; a fuel suction portion 50; and a fuel discharge-relief portion 60.

The main body portion 10 has a pump body 11 working as a pump housing. The fuel supply portion 30 is provided at an upper side of the pump body 11, while the plunger portion 40 is provided at a lower side of the pump body 11. A fuel pressurizing chamber 12 is formed between the fuel supply portion 30 and the plunger portion 40.

The fuel suction portion 50 (a left-hand side in FIG. 1) as well as the fuel discharge-relief portion (a right-hand side in FIG. 1) is provided in a direction almost perpendicular to a direction connecting the fuel supply portion 30 and the plunger portion 40 with each other. Hereinafter, structures for the fuel supply portion 30, the plunger portion 40, the fuel suction portion 50 and the fuel discharge-relief portion 60 will be explained more in detail.

At first, the structure for the fuel supply portion 30 will be explained.

The pump body 11 has a recessed portion 13 on the upper side thereof opposite to a cylinder 16. The recessed portion 13 is opened to an outside of the pump body 11. A cover member 14 closes an open end of the recessed portion 13. A fuel chamber 31 is formed by the recessed portion 13 and the cover member 14. The fuel from the fuel tank (not shown) is supplied into the fuel chamber 31 via the fuel inlet port (not shown) of the fuel pump 1.

A damper unit 32 and a wave washer 38 are accommodated in the fuel chamber 31. The damper unit 32 is composed of a pulsation damper 35, a body-side supporting member 36 and a cover-side supporting member 37.

The pulsation damper 35 is formed of two diaphragms 33 and 34, outer peripheral portions of which are fixed to each other to form an air-tight chamber, in which gas of a predetermined pressure is sealed. The pulsation damper 35 decreases pulsation of fuel pressure when the diaphragms 33 and 34 are elastically deformed depending on fuel pressure variation in the fuel chamber 31.

The body-side supporting member 36 is provided at a bottom portion 15 of the recessed portion 13 and an upper end thereof is in contact with the outer periphery of the pulsation damper 35 on a lower side (on a side to the pump body 11). The cover-side supporting member 37 is in contact with the outer periphery of the pulsation damper 35 on an upper side (on a side to the cover member 14). According to such a structure, the pulsation damper 35 is interposed between the body-side and cover-side supporting members 36 and 37 in the vertical direction.

The wave washer 38 is provided between the cover member 14 and the cover-side supporting member 37 for pressing the damper unit 32 toward the bottom portion 15 of the recessed portion 13, so that the damper unit 32 is firmly supported in the fuel chamber 31.

Next, the plunger portion 40 will be explained.

The plunger portion 40 is composed of; a plunger 41; an oil-seal holder 42; a spring seat 43; a plunger spring 44; and so on. The plunger 41 has a large-diameter portion 411 and a small-diameter portion 412, which are integrally formed with each other and reciprocates in its axial direction (in the vertical direction). The large-diameter portion 411, which is formed on a side to the fuel pressurizing chamber 12, reciprocates to slide on an inner peripheral surface of the cylinder 16. The small-diameter portion 412, which is formed on a side opposite to the fuel pressurizing chamber 12, is inserted into the oil-seal holder 42.

The oil-seal holder 42 is arranged at a lower end of the cylinder 16. It has a base portion 421 located at and surrounding the small-diameter portion 412 of the plunger 41 in its circumferential direction, and a press-insert portion 422 inserted into the pump body 11.

The base portion 421 has a seal member 423, which is composed of an inner ring made of Teflon (a registered trademark) and an outer O-ring. A thickness of oil film formed around the small-diameter portion 412 of the plunger 41 is adjusted by the seal member 423, to thereby suppress leakage of the fuel to an engine side.

The base portion 421 further has an oil-seal member 425 at its lower end. A thickness of oil film formed around the small-diameter portion 412 of the plunger 41 is likewise adjusted by the oil-seal member 425, to thereby suppress leakage of oil.

The press-insert portion 422 extends from an outer periphery of the base portion 421 in a cylindrical shape. A cross sectional shape of such a cylindrical portion has a U-shape. A recessed portion 17 is formed in the pump body 11 at a position corresponding to the press-insert portion 422. The press-insert portion 422 is inserted into the recessed portion 17 so that the press-insert portion 422 is pressed against an inner peripheral surface of the recessed portion 17.

The spring seat 43 is arranged at a lower end of the plunger 41. The lower end of the plunger 41 is in contact with a tappet (not shown), which is in contact with an outer surface of a cam member (not shown) formed with a cam shaft so that the tappet is reciprocated in an axial direction in accordance with a cam profile when the cam shaft is rotated.

A lower end of the plunger spring 44 is held by the spring seat 43, while an upper end thereof is supported by an annular groove formed in the press-insert portion 422 of the oil-seal holder 42. According to such a structure, the plunger 41 is biased by the plunger spring 44 toward the tappet. When the plunger 41 is reciprocated by the rotation of the cam shaft, volume of the fuel pressurizing chamber 12 is changed in accordance with a reciprocal movement of the large-diameter portion 411 of the plunger 41.

A variable-volume chamber 45 is formed around the small-diameter portion 412 of the plunger 41. Namely, a space, which is surrounded by the cylinder 16 of the pump body 11, a lower end surface of the large-diameter portion 411 of the plunger 41 (that is, a stepped portion between the large-diameter and the small-diameter portions 411 and 412), an outer peripheral surface of the small-diameter portion 412 of the plunger 41 and the seal member 423 of the oil-seal holder 42, forms the variable-volume chamber 45. The seal member 423 of the oil-seal holder 42 fluid-tightly seals the variable-volume chamber 45, so as to suppress or prevent leakage of the fuel from the variable-volume chamber 45 to the engine side.

The variable-volume chamber 45 is communicated to the bottom portion 15 of the fuel chamber 31 via a first annular fuel passage 427 formed between the press-insert portion 422 and the recessed portion 17 in the radial direction, a second annular fuel passage 428 formed at a bottom (an upper end) of the recessed portion 17, and a fuel communication passage 18 (indicated by a dotted line in FIG. 1) formed in the pump body 11.

Then, the fuel suction portion 50 will be explained.

The fuel suction portion 50 is composed of; a cylindrical portion 51 formed by the pump body 11; a valve cover member 52 for covering an open end of the cylindrical portion 51; a connector 53 and so on.

The cylindrical portion 51 is formed in an almost cylindrical shape to form therein a fuel suction chamber 55. A valve-seat body 56 is arranged in the fuel suction chamber 55. A suction valve 57 is arranged in the valve-seat body 56. The fuel suction chamber 55 is communicated to the fuel chamber 31 through a fuel communication passage 58.

The suction valve 57 is in contact with a needle 59, which extends through the valve cover member 52 to an inside of the connector 53. The connector 53 has an electromagnetic coil 531 and terminals 532 for supplying electric power to the electromagnetic coil 531. A fixed core 533, a movable core 534 and a spring 535 (provided between the fixed core 533 and the movable core 534) are arranged at respective predetermined positions in the inside of the electromagnetic coil 531. The movable core 534 is integrally fixed to the needle 59.

According to the above structure, when the electric power is supplied to the electromagnetic coil 531 via the terminals 532 of the connector 53, an electromagnetic attracting force is generated between the fixed core 533 and the movable core 534. Then, the movable core 534 is moved toward the fixed core 533, so that the needle 59 is correspondingly moved in a direction away from the fuel pressurizing chamber 12 (in a left-hand direction in FIG. 1). Since the movement of the suction valve 57 is no longer restricted by the needle 59 in this operation, the suction valve 57 is moved toward its valve seat formed in the valve-seat body 56. When the suction valve 57 is seated on its valve seat, the communication between the fuel suction chamber 55 and the fuel pressurizing chamber 12 is shut off.

When no electric power is supplied to the electromagnetic coil 531, the electromagnetic attracting force is not generated, so that the movable core 534 and the needle 59 are moved by the spring 535 in the direction toward the fuel pressurizing chamber 12. The suction valve 57 is thereby moved by the needle 59 toward the fuel pressurizing chamber 12 and held at such position (at a position on a side of the fuel pressurizing chamber 12). Then, the suction valve 57 is separated from the valve-seat body 56. The fuel suction chamber 55 is communicated again to the fuel pressurizing chamber 12.

Now, the fuel discharge-relief portion 60 will be explained.

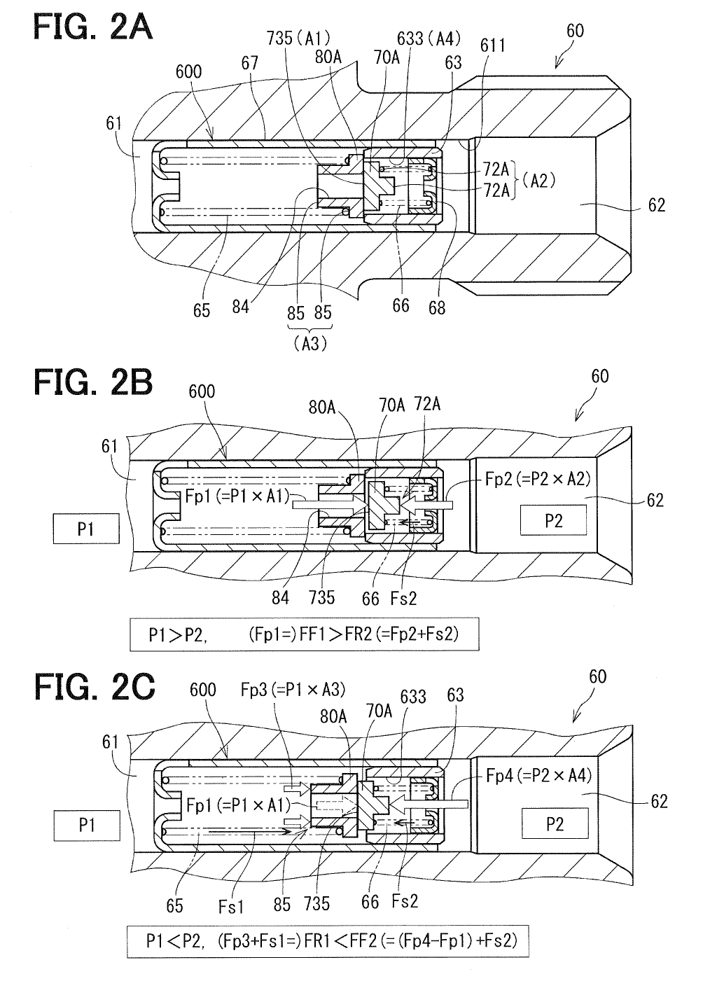

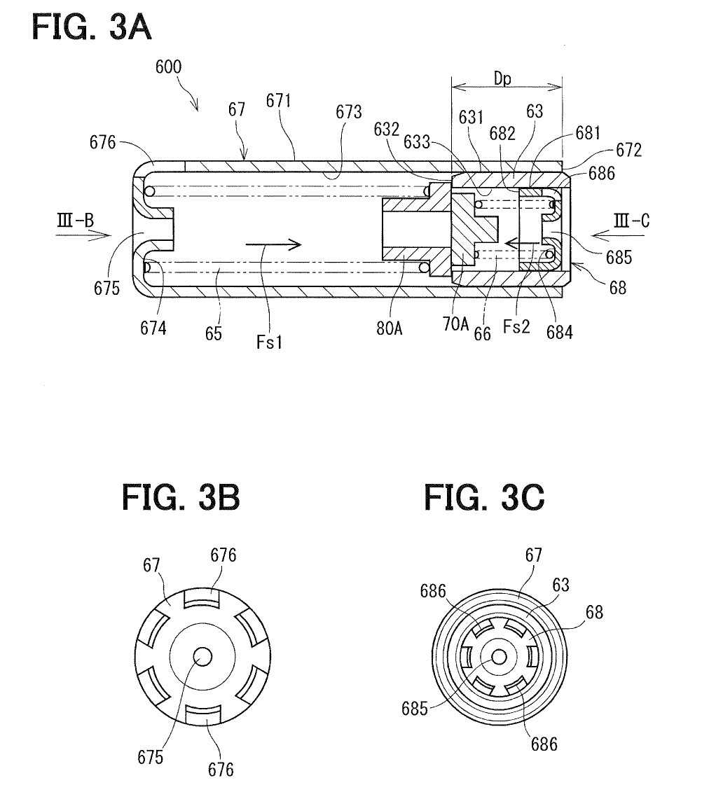

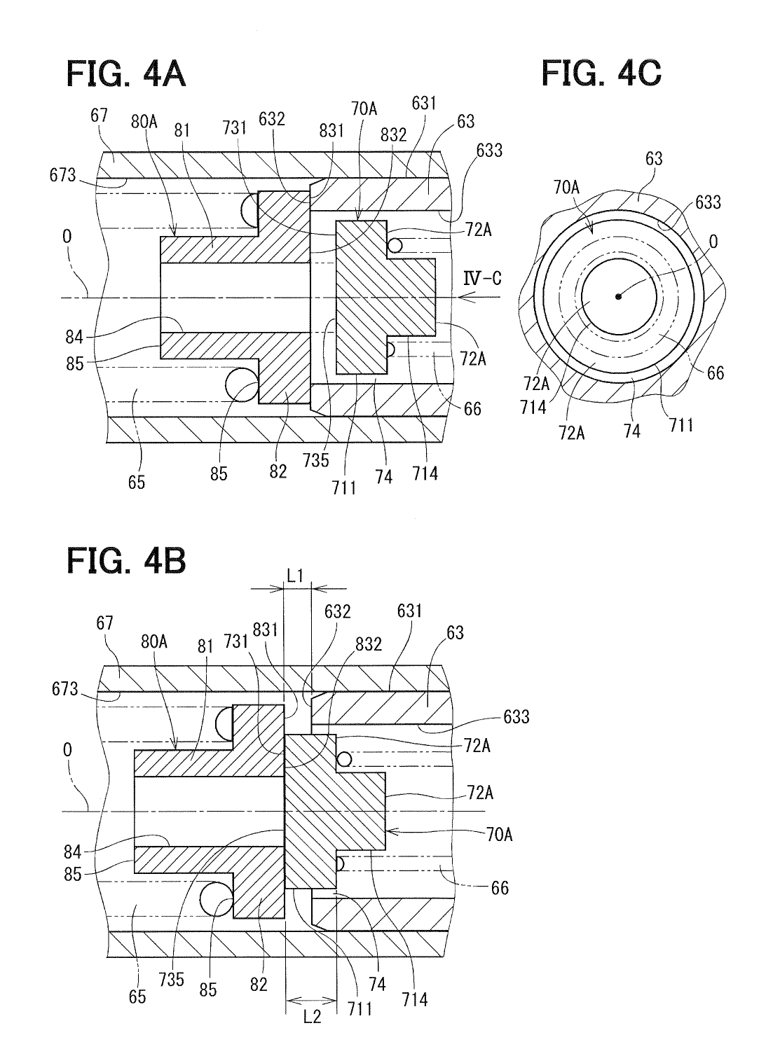

The fuel discharge-relief portion 60 has a fuel discharge passage 61, an open end of which forms a fuel discharge port 62. A discharge-relief valve unit 600 is accommodated in the fuel discharge passage 61. FIGS. 2A to 2C are schematic cross sectional views showing the fuel discharge passage 61, in which the discharge-relief valve unit 600 is accommodated. FIG. 3A is a schematic cross sectional view showing the discharge-relief valve unit 600. FIGS. 4A and 4B are schematically enlarged cross sectional views showing valve positions for explaining valve opening and valve closing operations of the discharge-relief valve unit 600.

As shown in FIGS. 2A to 2C and FIGS. 3A to 3C, the discharge-relief valve unit 600 is a cylindrical sub-assembly unit (a sub component), which is composed of the following seven parts; a first spring holder (a first holding member) 67; an adjusting pipe (a seat member) 63; a discharge valve body 70A; a relief valve body 80A; a first spring (a first biasing member) 65; a second spring (a second biasing member) 66; and a second spring holder 68.

As regards the discharge-relief valve unit 600, an outer wall surface 671 of the first spring holder 67 is press inserted into an inner wall surface 611 of the fuel discharge passage 61. Hereinafter, a left-hand side of the discharge-relief valve unit 600 in FIG. 3A (and in the other drawings) is also referred to as “a pressurizing-chamber side”, while a right-hand side of the discharge-relief valve unit 600 in FIG. 3A (and in the other drawings) is also referred to as “a discharge-port side”.

A left-hand end of a pipe member for the first spring holder 67 is bent in a radial-inward direction (on the pressurizing-chamber side), to thereby form a spring seat 674 for supporting a left-hand end of the first spring 65. A center fuel passage 675 is formed at such left-hand end of the first spring holder 67. Multiple notched fuel passages 676 are formed at the left-hand end and at an outer peripheral portion of the pipe member for the first spring holder 67 (in a circumferential direction of the pipe member).

An outer wall surface 631 of the adjusting pipe 63 is press inserted into an inner wall surface 673 of the first spring holder 67 at a right-hand end thereof (on the discharge-port side). An axial end surface of the adjusting pipe 63 at the left-hand side (at the pressurizing-chamber side) forms a first seat portion 632 for defining a valve closing position for the relief valve body 80A, which is biased by the first spring 65 in the right-hand direction toward the first seat portion 632. Therefore, when a press-insert depth “Dp” of the adjusting pipe 63 from an end surface 672 (a right-hand end) of the first spring holder 67 is controlled, a load of the first spring 65 (that is, “a first biasing force Fs1”) can be adjusted.

The second spring holder 68 is press inserted into an inner wall surface 633 of the adjusting pipe 63. A right-hand end of a pipe member for the second spring holder 68 is bent in a radial-inward direction (on the discharge-port side), to thereby form a spring seat 684 for supporting a right-hand end of the second spring 66. A center fuel passage 685 is formed at such right-hand end of the second spring holder 68. Multiple notched fuel passages 686 are likewise formed at the right-hand end and at an outer peripheral portion of the pipe member for the second spring holder 68 (in a circumferential direction of the pipe member).

Structures of the discharge valve body 70A and the relief valve body 80A will be explained with reference to FIGS. 2A to 2c and FIGS. 4A and 4B.

The discharge valve body 70A is formed in an almost cylindrical shape, an end surface (a first axial end) of which on a left-hand side (on the pressurizing-chamber side) is perpendicular to a center axis “O”. A portion of the end surface (on the pressurizing-chamber side), which faces to a communication passage 84 of the relief valve body 80A, forms a first pressure receiving portion 735, while a remaining portion of the end surface of the discharge valve body 70A (on the pressurizing-chamber side), which is an annular flat area and will be in contact with the relief valve body 80A, forms a first contacting portion 731.

A projecting portion 714 is formed in the discharge valve body 70A on the right-hand side thereof (on the discharge-port side). An outer peripheral surface of the projecting portion 714 supports a left-hand end of the second spring 66 (more exactly, engaged with an inside thereof). An end surface of the discharge valve body 70A (on the discharge-port side for supporting the left-hand end of the second spring 66) and a forward end surface of the projecting portion 714 are collectively referred to as a second axial end of the discharge valve body 70A, wherein the second axial end forms a second pressure receiving portion 72A.

An outer diameter of an outer wall portion 711 is made to be slightly smaller (for example, several mm) than an inner diameter of the inner wall surface 633 of the adjusting pipe 63. As a result, an annular fuel passage 74 is formed between the inner wall surface 633 of the adjusting pipe 63 and the outer wall portion 711 of the discharge valve body 70A.

The relief valve body 80A is composed of a small-diameter portion 81 on the left-hand side (on the pressurizing-chamber side) and a large-diameter portion 82 on the right-hand side (on the discharge-port side). In addition, the relief valve body 80A has the communication passage 84 along the center axis “O” for connecting a space of the fuel discharge passage at the left-hand side and another space of the fuel discharge passage at the right-hand side with each other.

An outer peripheral surface of the small-diameter portion 81 supports a right-hand end of the first spring 65. An end surface of the large-diameter portion 82 on the left-hand side (on the pressurizing-chamber side) is engaged with the right-hand end of the first spring 65. An end surface (a second axial end) of the large-diameter portion 82 on the right-hand side (on the discharge-port side) forms a surface perpendicular to the center axis “O”.

A portion of the end surface (the second axial end) of the relief valve body 80A, on the right-hand side (which is opposing to and will be in contact with the first seat portion 632) forms a second contacting portion 831. A remaining portion of the end surface, which is neighboring to the communication passage 84 and facing to the first contacting portion 731 of the discharge valve body 70A, forms a second seat portion 832.

An end surface of the large-diameter portion 82 on the left-hand side (on the pressurizing-chamber side) for supporting the right-hand end of the first spring 65 and an end surface of the small-diameter portion 81 on the left-hand side are collectively referred to as a first axial end of the relief valve body 80A, wherein the first axial end forms a third pressure receiving portion 85.

An operation of the discharge valve body 70A and the relief valve body 80A will be explained with reference to FIGS. 2A to 2C and FIGS. 4A and 4B.

FIG. 2B shows a valve opening operation of the discharge valve body 70A. Hereinafter, the following terms and signs have the following meanings. Signs in parentheses show respective dimension.

“P1” is a fuel pressure (Pa) in the fuel pressurizing chamber 12:

“A1” is a pressure receiving area (m²) of the first pressure receiving portion 735:

“Fp1 (=P1×A1)” is “a first pressure applying force” (N), which is applied to the first pressure receiving portion 735 as a result that the fuel pressure “P1” of the fuel pressurizing chamber 12 is transmitted through the communication passage 84:

“P2” is a fuel pressure (Pa) in the fuel discharge port 62:

“A2” is a pressure receiving area (m²) of the second pressure receiving portion 72A:

“Fp2 (=P2×A2)” is “a second pressure applying force” (N), which is applied to the second pressure receiving portion 72A as a result that the fuel pressure “P2” of the fuel discharge port 62 is transmitted through the center fuel passage 685:

“Fs2” is “a second biasing force” (N) of the second spring 66:

“FF1” is “a first forward force” (N) which is applied to the discharge valve body 70A in its valve opening direction (in the right-hand direction):

“FR2” is “a second rearward force” (N) which is applied to the discharge valve body 70A in its valve closing direction (in the left-hand direction):

In a case that the fuel pressure “P1” in the fuel pressurizing chamber 12 is higher than the fuel pressure “P2” in the fuel discharge port 62 (P1>P2), the first forward force “FF1” and the second rearward force “FR2” can be expressed in the following formulas:

FF1=Fp1 <Formula 1>

FR2=Fp2+Fs2 <Formula 2>

The first forward force “FF1” is equal to the first pressure applying force “Fp1”, because the second contacting portion 831 of the relief valve body 80A is in contact with the first seat portion 632 of the adjusting pipe 63 and thereby the spring force of the first spring 65 is not applied to the discharge valve body 70A.

The second rearward force “FR2” is a total force of the second pressure applying force “Fp2” and the second biasing force “Fs2”.

In a case that the first forward force “FF1” is smaller than the second rearward force “FR2” (“FF1”≦“FR2”), the first contacting portion 731 of the discharge valve body 70A is seated on the second seat portion 832 of the relief valve body 80A, to thereby close the communication passage 84. Hereinafter, this operation is referred to as “the discharge valve is closed”.

In a case that the first forward force “FF1” becomes larger than the second rearward force “FR2” (“FF1”>“FR2”) as shown in FIGS. 2B and 4A, the discharge valve body 70A is moved toward the discharge-port side (in the right-hand direction), to thereby open the communication passage 84. Hereinafter, this operation is also referred to as “the discharge valve is opened”. When the discharge valve is opened, the fuel in the fuel pressurizing chamber 12 is pumped out from the fuel discharge port 62 via the annular fuel passage 74.

During the operation in which the discharge valve is opened, the fuel pressure “P1” of the fuel pressurizing chamber 12 is applied not only to the first pressure receiving portion 735 of the discharge valve body 70A via the communication passage 84 of the relief valve body 80A but also to the end surface of the relief valve body 80A on the left-hand side (the pressurizing-chamber side), so that the relief valve body 80A is continuously pushed toward the adjusting pipe 63.

FIG. 2C shows a valve closing operation of the discharge valve body 70A. Hereinafter, the following additional terms and signs have the following meanings.

“Fs1” is “a first biasing force” (N) of the first spring 65:

“A3” is a pressure receiving area (m²) of the third pressure receiving portion 85:

“Fp3 (=P1×A3)” is “a third pressure applying force” (N), which is applied to the third pressure receiving portion 85 as a result that the fuel pressure “P1” of the fuel pressurizing chamber 12 is applied thereto:

“A4” is a (fourth) pressure receiving area (m²) corresponding to an inside cross sectional area of the inner wall surface 633 of the adjusting pipe 63:

“Fp4 (=P2×A4)” is “a fourth pressure applying force” (N), which is calculated by multiplying the fuel pressure “P2” of the fuel discharge port 62 by the fourth pressure receiving area “A4”, wherein the fourth pressure applying force “Fp4” is a total force of the second pressure applying force “Fp2” (the fuel pressure “P2” of the discharge port 62 is applied to the relief valve body 80A via the discharge valve body 70A) and such a force directly applied to the relief valve body 80A (that is, the fuel pressure “P2” of the discharge port 62 is directly applied to the relief valve body 80A via the annular fuel passage 74):

“FR1” is “a first rearward force” (N) which is applied to the relief valve body 80A in its valve closing direction (in the right-hand direction):

“FF2” is “a second forward force” (N) which is applied to the relief valve body 80A in its valve opening direction (in the left-hand direction):

In a case that the fuel pressure “P1” in the fuel pressurizing chamber 12 is lower than the fuel pressure “P2” in the fuel discharge port 62 (P1<P2), the second forward force “FF2” and the first rearward force “FR1” can be expressed in the following formulas:

FF2=(Fp4−Fp1)+Fs2 <Formula 3>

FR1=Fp3+Fs1 <Formula 4>

The second forward force “FF2” is a total force of a force, which is calculated by subtracting the first pressure applying force “Fp1” from the fourth pressure applying force “Fp4”, and the second biasing force “Fs2”.

The first rearward force “FR1” is a total force of the third pressure applying force “Fp3” and the first biasing force “Fs1”.

In a case that the second forward force “FF2” is smaller than the first rearward force “FR1” (“FF2”≦“FR1”), the second contacting portion 831 of the relief valve body 80A is seated on the first seat portion 632 of the adjusting pipe 63, to thereby shut off fuel flow from the discharge port 62 to the fuel pressurizing chamber 12. Hereinafter, this operation is referred to as “the relief valve is closed”.

In a case that the second forward force “FF2” becomes larger than the first rearward force “FR1” (“FF2”>“FR1”), as shown in FIGS. 2C and 4B, the discharge valve body 70A as well as the relief valve body 80A is moved in the left-hand direction (to the pressurizing-chamber side), to thereby allow the fuel flow from the discharge port 62 to the fuel pressurizing chamber 12. Hereinafter, this operation is referred to as “the relief valve is opened”. When the relief valve is opened, the fuel is returned from the discharge port 62 to the fuel pressurizing chamber 12 via the annular fuel passage 74 and a space between an outer peripheral surface of the relief valve body 80A and the inner wall surface 673 of the first spring holder 67.

An axial length “L2” of the outer wall portion 711 of the discharge valve body 70A is made longer than a maximum lift amount “L1” of the relief valve body 80A, so that the discharge valve body 70A does not drop out from the inside space surrounded by the inner wall surface 633 of the adjusting pipe 63 even in the case of the movement of the relief valve body 80A to its maximum lifted position.

An operation of the high pressure fuel pump 1 will be explained.

### (i) Fuel Suction Operation (Suction Stroke):

When the plunger 41 is moved in the downward direction from its top dead center to its bottom dead center in accordance with the rotation of the cam shaft, the volume of the fuel pressurizing chamber 12 is increased and thereby the fuel pressure therein is decreased. The first contacting portion 731 of the discharge valve body 70A is brought into contact with the second seat portion 832 of the relief valve body 80A, to thereby close the communication passage 84.

In this operation, the movable core 534 and the needle 59 are moved by the biasing force of the spring 535 in the right-hand direction (to the pressurizing-chamber side), because the power supply to the electromagnetic coil 531 is cut off. Then, the needle 59 is in contact with the suction valve 57 to open the suction valve 57 and maintain the opened condition. As a result, the fuel is sucked into the fuel pressurizing chamber 12 from the fuel suction chamber 55.

In the suction stroke, the volume of the variable volume chamber 45 is decreased in accordance with the downward movement of the plunger 41. Therefore, the fuel in the variable volume chamber 45 is pushed out to the fuel chamber 31 via the fuel communication passage 18.

A ratio of the cross sectional areas between the large-diameter portion 411 of the plunger 41 and the variable volume chamber 45 is almost 1:0.6. Accordingly, a ratio of a volume increase in the fuel pressurizing chamber 12 with respect to a volume decrease in the variable volume chamber 45 becomes almost 1:0.6. In other words, about 60% of the fuel, which is sucked into the fuel pressurizing chamber 12, is supplied from the variable volume chamber 45 via the fuel communication passage 18, while the remaining 40% of the fuel is supplied from the fuel inlet port (not shown) of the high pressure fuel pump 1.

### (ii) Flow-Rate Control Operation (Flow-Rate Control Stroke):

When the plunger 41 is moved in the upward direction from the bottom dead center to the top dead center in accordance with the rotation of the cam shaft, the volume of the fuel pressurizing chamber 12 is decreased. In this operation, the power supply to the electromagnetic coil 531 is still kept in the cut-off condition until a predetermined timing, so that the suction valve 57 is kept in the valve opened condition. Accordingly, the low pressure fuel, which has been introduced into the fuel pressurizing chamber 12, is returned to the fuel suction chamber 55 via a fuel communication passage formed in the fuel suction portion 50.

When the electric power supply to the electromagnetic coil 531 is started at the predetermined timing during the upward movement of the plunger 41, the electromagnetic attracting force is generated between the fixed core 533 and the movable core 534. When the electromagnetic attracting force becomes larger than the biasing force of the spring 535, the movable core 534 as well as the needle 59 is moved in the left-hand direction toward the fixed core 533. Then, since the restricting force by the needle 59 to the suction valve 57 is removed, the suction valve 57 is moved in the left-hand direction to its valve closing condition.

(iii) Fuel Pressurizing Operation (Fuel Pressurizing Stroke):

After the suction valve 57 is closed, the fuel pressure “P1” in the fuel pressurizing chamber 12 is increased in accordance with the upward movement of the plunger 41. When the first forward force “FF1” becomes larger than the second rearward force “FR2” (“FF1”>“FR2”), the discharge valve body 70A is moved in the right-hand direction (to the discharge-port side), as shown in FIG. 2B. As a result, the fuel in the fuel pressurizing chamber 12 is pumped out from the discharge port 62 via the annular fuel passage 74.

Even when the power supply to the electromagnetic coil 531 is cut off during the fuel pressurizing stroke, the valve closed condition of the suction valve 57 is maintained, because the fuel pressure “P1” of the fuel pressurizing chamber 12 applied to the suction valve 57 is larger than the biasing force of the spring 535.

During the flow-rate control stroke and the fuel pressurizing stroke, the volume of the variable volume chamber 45 is increased in accordance with the upward movement of the plunger 41, so that the fuel is supplied from the fuel chamber 31 into the variable volume chamber 45 via the fuel communication passage 18. In this operation, about 60% of the low pressure fuel, which has been discharged from the fuel pressurizing chamber 12 to the fuel chamber 31, is sucked into the variable volume chamber 45 from the fuel chamber 31.

According to the high pressure fuel pump 1, the above suction stroke, the flow-rate control stroke and the fuel pressurizing stroke are repeatedly carried out, in order to pressurize the sucked fuel and to pump out the pressurized fuel to the fuel common rail. The fuel common rail accumulates the high pressure fuel pumped out from the high pressure fuel pump. The high pressure fuel is injected from the fuel injectors, power supply to which is controlled by an ECU. The fuel common rail, the injectors and the ECU are not shown in the drawings.

When the fuel pressure in the fuel common rail is lower than a predetermined pressure, namely, when the second forward force “FF2” based on the fuel pressure “P2” of the discharge port 62 is lower than the first rearward force “FR1” (“FF2”≦“FR1”), the first contacting portion 731 of the discharge valve body 70A is seated on the second seat portion 832 of the relief valve body 80A, to thereby close the communication passage 84. In addition, the second contacting portion 831 of the relief valve body 80A is seated on the first seat portion 632 of the adjusting pipe 63, so that the relief valve is closed.

In a case that the fuel pressure in the fuel common rail was increased due to any abnormal condition, and thereby the second forward force “FF2” would become higher than the first rearward force “FR1” (“FF2”>“FR1”), the discharge valve body 70A as well as the relief valve body 80A is moved in the left-hand direction (to the pressurizing-chamber side) in order to allow the fuel flow from the fuel discharge port 62 to the fuel pressurizing chamber 12, as shown in FIG. 2C or FIG. 4B. As above, the relief valve is opened.

The present embodiment has the following advantages:

(A-1) According to the present embodiment, the discharge valve body 70A and the relief valve body 80A are coaxially arranged in series with each other and accommodated in the one fuel discharge passage 61. Accordingly, when compared with the conventional fuel pump, according to which the discharge valve and the relief valve are arranged in parallel to each other and accommodated in respective fuel passages, the structure of the fuel pump of the present embodiment can be more simplified.

In addition, it is not necessary to independently form a fuel discharge passage and a fuel relief passage in the pump body 11. One fuel passage (the fuel discharge passage 61) is sufficient in the present embodiment. Furthermore, it is possible to consolidate multiple manufacturing and/or assembling steps into a smaller number of steps.

In addition, the end surface of the relief valve body 80A on the right-hand side (on the discharge-port side) has not only the function as the contacting portion but also the function as the seat portion for the discharge valve body 70A. Therefore, it is not necessary to manufacture a separate valve member working as the seat portion for the discharge valve body 70A.

As above, according to the present embodiment, the size of the pump body 11 can be made smaller and the manufacturing cost can be largely reduced.

(A-2) According to the present embodiment, when the discharge valve is opened, the fuel pressure “P1” of the fuel pressurizing chamber 12 is applied not only to the first pressure receiving portion 735 of the discharge valve body 70 via the communication passage 84 but also to the end surface of the relief valve body 80A on the left-hand side (on the pressurizing-chamber side), so that the relief valve body 80A is pushed toward the adjusting pipe 63. As a result, even when the fuel pressure in the fuel pressurizing chamber becomes higher than the relief valve opening pressure during the pump-out operation, the relief valve will not be opened. Accuracy for controlling the flow-rate of the fuel can be assured.

A dead volume for the fuel pressurizing chamber 12 corresponds to a space from the fuel pressurizing chamber 12 to the valve body (80A/70A) in the fuel discharge passage 61. In other words, according to the conventional fuel pump, the dead volume exists in both of the fuel discharge passage and the fuel relief passage. When compared with such conventional fuel pump, the dead volume can be decreased. Accordingly, the fuel discharge efficiency can be improved.

(A-3) The discharge valve body 70A is formed in the almost cylindrical shape, and the annular fuel passage 74 is formed between the inner wall surface 633 of the adjusting pipe 63 and the outer wall portion 711 of the discharge valve body 70A. Since the shape of the discharge valve body 70A is simplified, the manufacturing cost can be reduced.

(A-4) Since the second contacting portion 831 and the second seat portion 832 of the relief valve body 80A are formed in the flat surface, a number of manufacturing steps (such as, a cutting step, a grinding step and so on) can be decreased to thereby reduce the manufacturing cost.

In particular, according to the present embodiment, since the second contacting portion 831 and the second seat portion 832 are formed on the same flat surface, the number of manufacturing steps for the cutting step and the grinding step can be further decreased to reduce the manufacturing cost.

(A-5) Since the discharge-relief valve unit 600 is formed as the sub-assembly unit/component, it has the following advantages (5a) to (5c);

(5a) Since the discharge-relief valve unit 600 can be manufactured in an assembling line, which is different from a main assembling line for the high pressure fuel pump 1, a takt time can be reduced;

(5b) In a manufacturing process (for example, an inspection process) the relief valve opening pressure is inspected so that such relief valve opening pressure is controlled (adjusted) to be within a predetermined pressure range. According to the present embodiment, it is not necessary to mount the fuel pump (the pump body 11) in such an inspecting apparatus, but it is sufficient to mount the discharge-relief valve unit in the inspecting apparatus. Therefore, the inspecting apparatus can be made smaller and simplified. In addition, since weight of products (or components) to be inspected can be made smaller, working loads for workers can be decreased.

(5c) When the relief valve opening pressure cannot be adjusted within the predetermined pressure range due to some reasons in the above inspecting and/or adjusting process, such products should be destroyed as defective products. In a case that the inspection process will be done for the pump body 11, such a defective pump body 11, for which a large manufacturing cost has been already paid, will be destroyed. On the other hand, according to the present embodiment, the inspection process for the relief valve opening pressure can be done for the sub-assembly unit (the discharge-relief valve unit 600). Therefore, even in a case the defective product should be destroyed, only the sub-assembly unit will be destroyed. As above, it is possible to reduce loss cost in case of the defective products to be destroyed.

### Second Embodiment

In the following second to fifth embodiments, only a structure for the discharge valve body and/or the relief valve body is different from that of the first embodiment. The same reference numerals are given to such parts and/or components, which are substantially identical to those of the first embodiment.

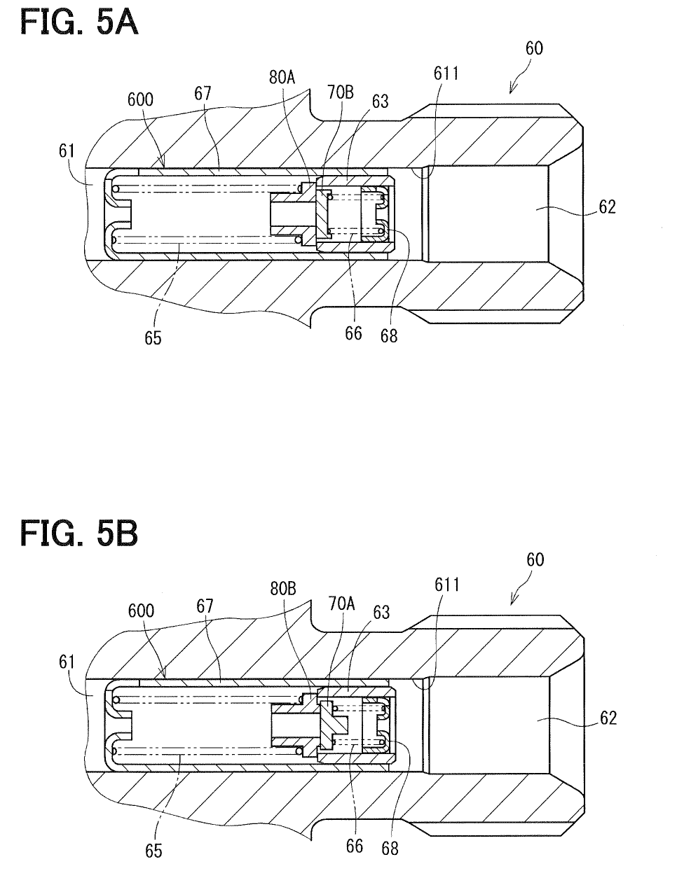

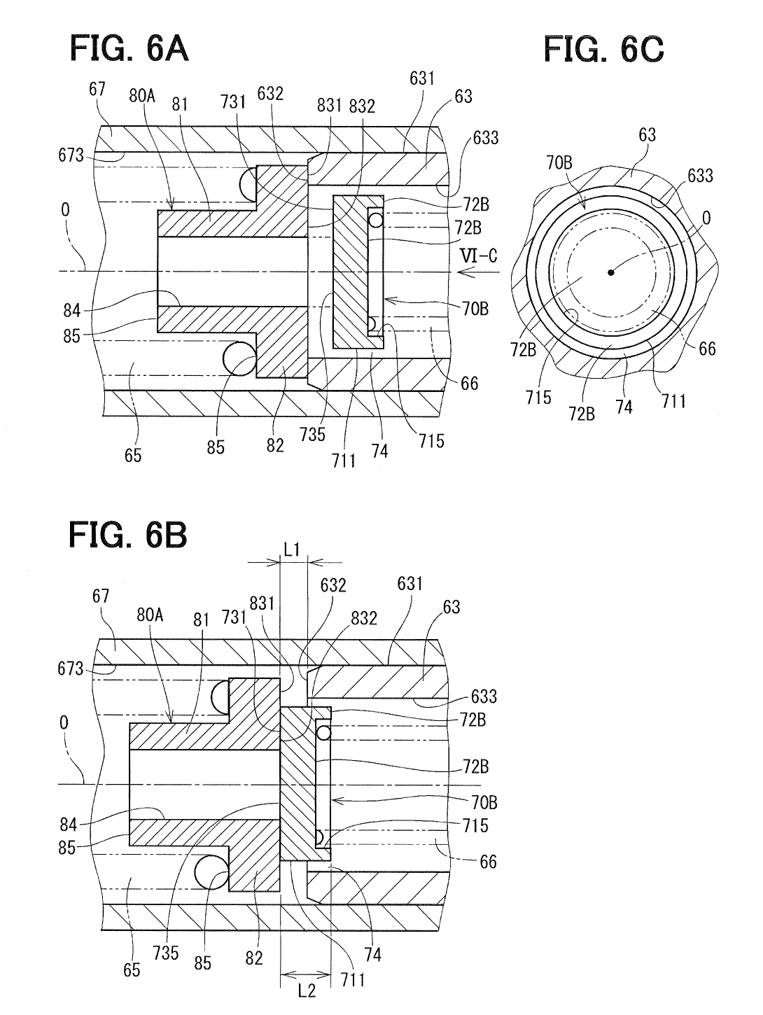

A second embodiment will be explained with reference to FIG. 5A and FIGS. 6A to 6C.

A discharge valve body 70B of the second embodiment has likewise the first contacting portion 731 and the first pressure receiving portion 735 on the end surface (the first axial end) of the left-hand side (on the pressurizing-chamber side). A recessed portion 715 is formed on the end surface (the second axial end) of the discharge valve body 70B on the right-hand side (on the discharge-port side). The left-hand end of the second spring 66 is guided (supported) by the recessed portion 715. The end surface of the discharge valve body 70B on the right-hand side as well as a bottom surface of the recessed portion 715 forms a second pressure receiving portion 72B. The annular fuel passage 74 is likewise formed between the inner wall surface 633 of the adjusting pipe 63 and the outer wall portion 711 of the discharge valve body 70B.

The first contacting portion 731 of the discharge valve body 70B is seated on the second seat portion 832 of the relief valve body 80A, when the discharge valve is closed. The discharge valve is opened, when the first forward force “FF1” acting on the discharge valve body 70B becomes larger than the second rearward force “FR2” (“FF1”>“FR2”). Then, the high pressure fuel in the fuel pressurizing chamber 12 is pumped out from the fuel discharge port 62 via the annular fuel passage 74.

The relief valve body 80A of the second embodiment is substantially the same to that of the first embodiment. The second contacting portion 831 of the relief valve body 80A is seated on the first seat portion 632 of the adjusting pipe (the seat member) 63, when the relief valve is closed. When the second forward force “FF2” acting on the relief valve body 80A, either directly or via the discharge valve body 70B, becomes larger than the first rearward force “FR1” (“FF2”>“FR1”), the relief valve body 80A is opened together with the discharge valve body 70B.

An axial length “L2” of the outer wall portion 711 of the discharge valve body 70B is made longer than the maximum lift amount “L1” of the relief valve body 80A, so that the discharge valve body 70B does not drop out from the inside space surrounded by the inner wall surface 633 of the adjusting pipe 63 even in the case of the movement of the relief valve body 80A to the maximum lifted position.

The second embodiment has the same advantages to the first embodiment. In addition, when compared with the first embodiment, since an axial length of the discharge valve body is smaller, the material cost can be reduced and weight saving can be achieved. As a result, a response of the discharge valve is improved. A generation of phenomenon of fuel reverse flow, which is a reverse flow of the discharged fuel flowing back into the fuel pressurizing chamber 12, and which may be caused by a delayed valve closing operation of the discharge valve, can be suppressed. Therefore, the fuel discharge efficiency cannot be decreased.

### Third Embodiment

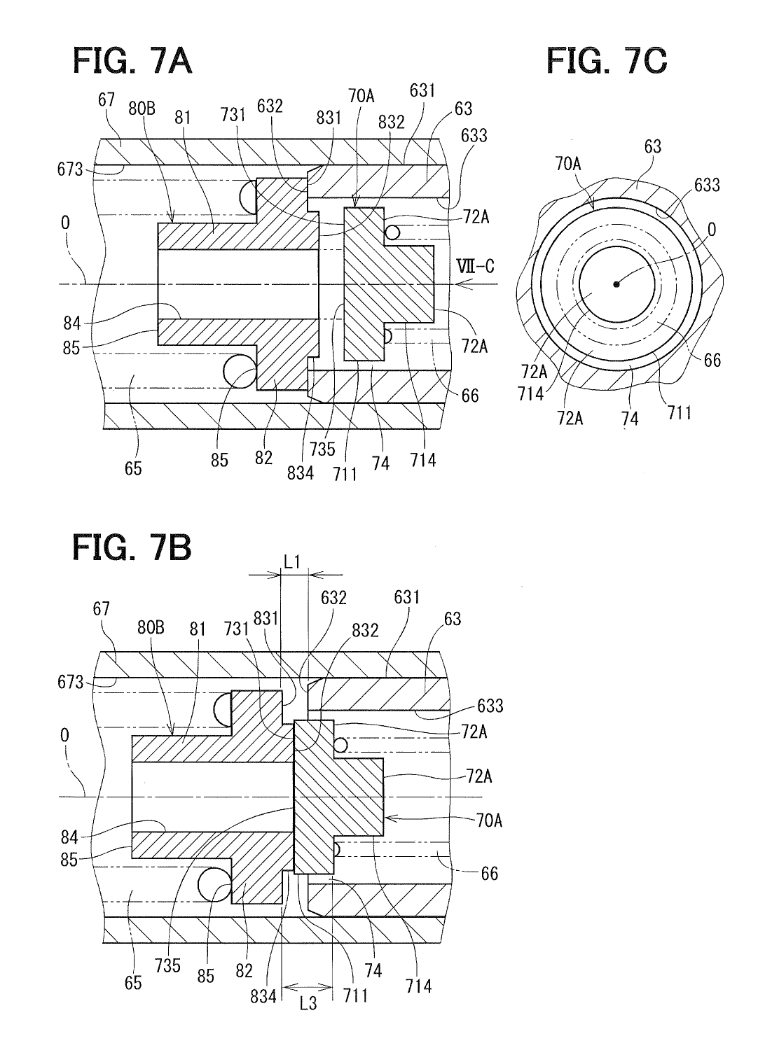

A third embodiment will be explained with reference to FIG. 5B and FIGS. 7A to 7C.

The discharge valve body 70A of the third embodiment is substantially the same to that of the first embodiment. The first contacting portion 731 of the discharge valve body 70A is seated on the second seat portion 832 of a relief valve body 80B, when the discharge valve is closed. When the first forward force “FF1” acting on the discharge valve body 70A becomes larger than the second rearward force “FR2” (“FF1”>“FR2”), the discharge valve is opened so that the high pressure fuel in the fuel pressurizing chamber 12 is pumped out from the fuel discharge port 62 via the annular fuel passage 74.

According to the relief valve body 80B of the third embodiment, both of the second seat portion 832 and the second contacting portion 831 are formed in the flat surfaces, but not on the same surface. The second seat portion 832 is displaced (projected) from the second contacting portion 831 on a side toward the discharge-port side (in the right-hand direction) by a stepped portion 834.

When the relief valve is closed, the second contacting portion 831 of the relief valve body 80B is seated on the first seat portion 632 of the adjusting pipe (the seat member) 63. When the second forward force “FF2” acting on the relief valve body 80B, either directly or via the discharge valve body 70A, becomes larger than the first rearward force “FR1” (“FF2”>“FR1”), the relief valve body 80B is opened together with the discharge valve body 70A.

An axial length “L3”, which is a total value of a length of the outer wall portion 711 of the discharge valve body 70A and a length of the stepped portion 834, is made longer than the maximum lift amount “L1” of the relief valve body 80B, so that the discharge valve body 70A does not drop out from the inside space surrounded by the inner wall surface 633 of the adjusting pipe 63 even in the case of the movement of the relief valve body 80B to the maximum lifted position.

The third embodiment has the substantially same advantages to the first embodiment. Even in a case that the maximum lift amount “L1” of the relief valve body 80B is relatively long, the axial length “L3” having a sufficient length can be obtained when making the outer wall portion 711 of the discharge valve body 70A longer, so that it is possible to prevent the discharge valve body 70A from coming out of the adjusting pipe 63.

A faster response is required for the discharge valve than the relief valve. It is, therefore, possible to more easily suppress the occurrence of the above phenomenon of the reverse fuel flow, when a mass of the discharge valve body 70A becomes smaller. According to the present embodiment, it is possible to assure the sufficient axial length “L3” by providing the stepped portion 834 in the relief valve body 80B, without making the size of the discharge valve body larger. Accordingly, the reverse fuel flow is suppressed, while the discharge valve body 70A is prevented from dropping out from the adjusting pipe 63.

### Fourth Embodiment

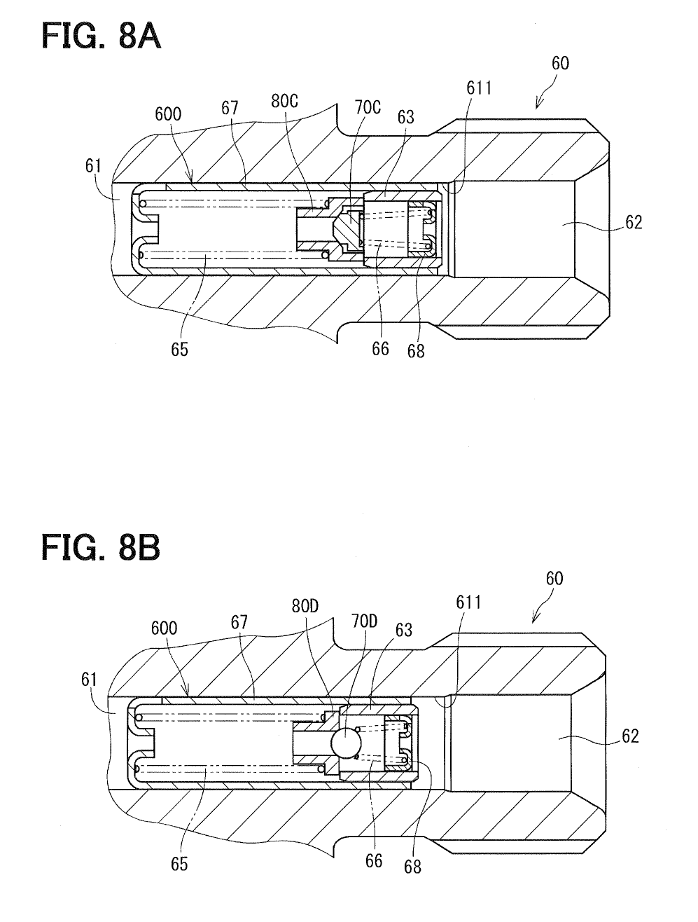

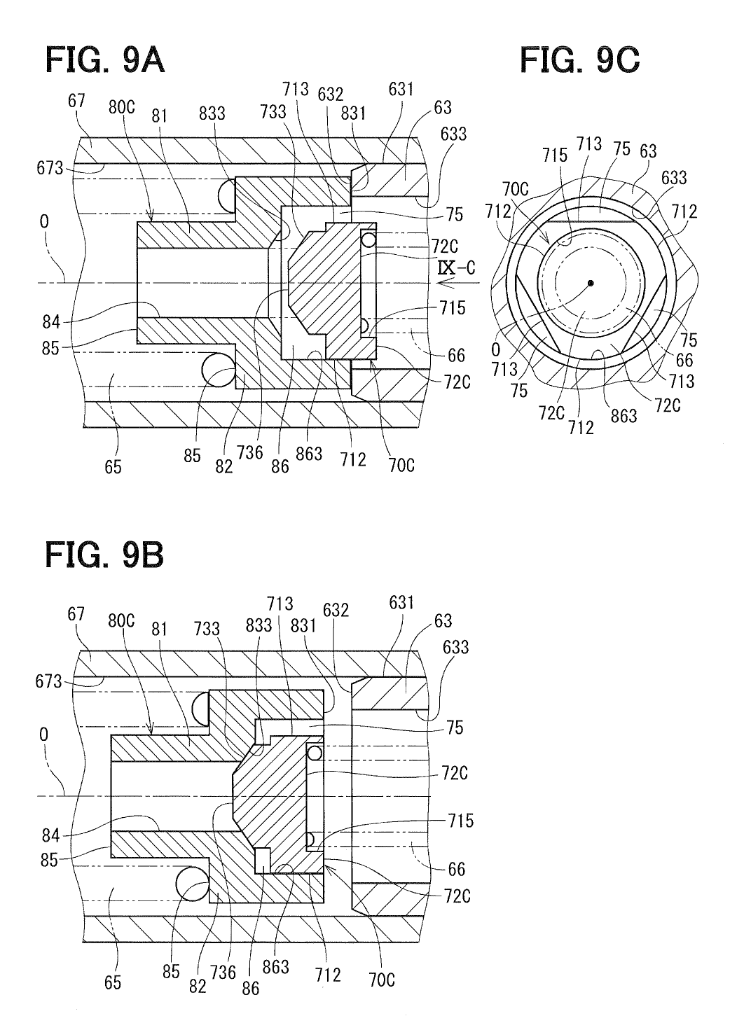

A fourth embodiment will be explained with reference to FIG. 8A and FIGS. 9A to 9C.

According to the fourth embodiment, a first contacting portion 733 of a discharge valve body 70C is formed in a tapered surface. A first pressure receiving portion 736 is formed on an end surface (a first axial end) of the discharge valve body 70C on a forward end side (the left-hand side) at its radial-inside area, so that the first pressure receiving portion 736 faces to the communication passage 84 of a relief valve body 80C.

Multiple (three) sliding surface portions 712 and multiple (three) flat surface portions 713 are formed at a radial-outer wall portion of the discharge valve body 70C. The sliding surface portions 712 slide on an inner guide surface 863 of the relief valve body 80C, while the flat surface portions 713 form fuel passages 75 between the inner guide surface 863 and the flat surface portions 713.

In the same manner to the discharge valve body 70B of the second embodiment, the recessed portion 715 is formed on the end surface of the discharge valve body 70C on the discharge-port side (on the right-hand side) for supporting (and guiding) the outer periphery of the second spring 66. The end surface of the discharge valve body 70C on the discharge-port side and the bottom surface of the recessed portion 715 form a second pressure receiving portion 72C.

The first contacting portion 733 of the discharge valve body 70C is seated on a second seat portion 833 of the relief valve body 80C, when the discharge valve is closed. In this operation, since the sliding surface portions 712 of the discharge valve body 70C are guided by the inner guide surface 863 of the relief valve body 80C, centers of the respective tapered surfaces for the first contacting portion 733 and the second seat portion 833 are adjusted. When the first forward force “FF1” acting on the discharge valve body 700 becomes larger than the second rearward force “FR2” (“FF1”>“FR2”), the discharge valve is opened so that the high pressure fuel in the fuel pressurizing chamber 12 is pumped out from the fuel discharge port 62 via the fuel passages 75.

The relief valve body 80C of the fourth embodiment has a recessed portion 86 on the discharge-port side (in a radial-inside of the large-diameter portion 82). The recessed portion 86 is opened to the right-hand direction (to the discharge-port side) at a radial-inside area of the second contacting portion 831, to form the inner guide surface 863. The second seat portion 833 of the tapered surface is formed at the bottom of the recessed portion 86.

The second contacting portion 831 of the relief valve body 80C is seated on the first seat portion 632 of the adjusting pipe (the seat member) 63, when the relief valve is closed. When the second forward force “FF2” acting on the relief valve body 80C, either directly or via the discharge valve body 70C, becomes larger than the first rearward force “FR1” (“FF2”>“FR1”), the relief valve body 80C is moved in the left-hand direction together with the discharge valve body 70C so that the relief valve is opened.

### Fifth Embodiment

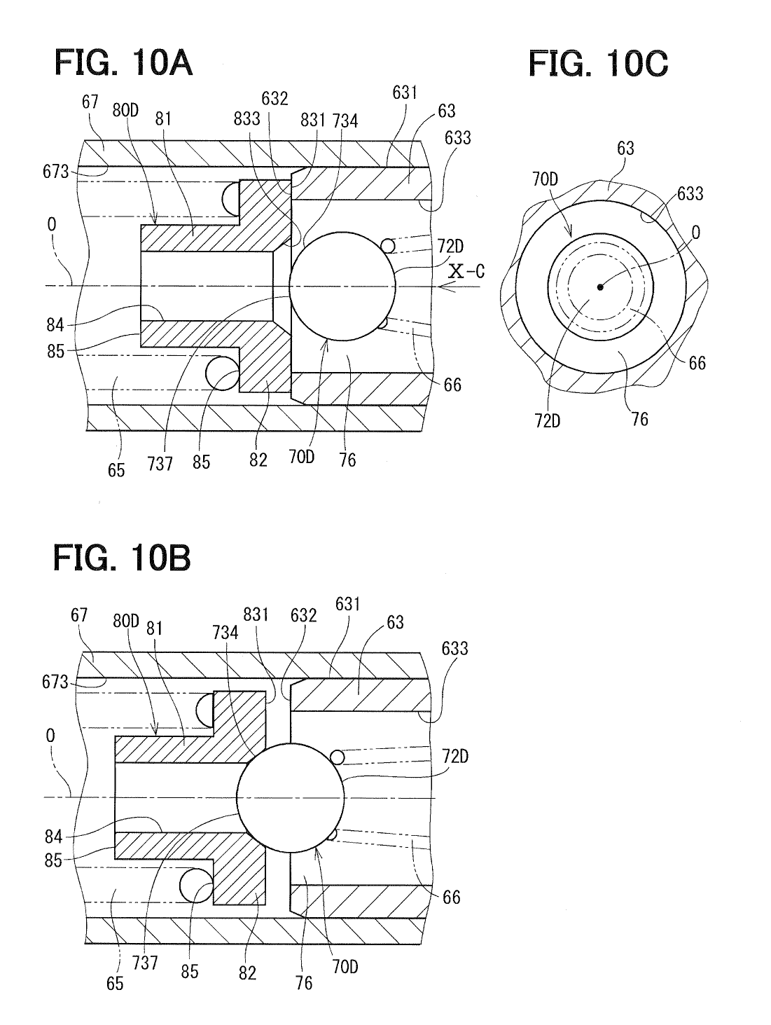

A fifth embodiment will be explained with reference to FIG. 8B and FIGS. 10A to 10C.

According to the fifth embodiment, a discharge valve body 70D is formed in a ball shape, for example, a steel ball is used. A hemi-spherical surface portion of the discharge valve body 70D, which faces to the second seat portion 833 of a relief valve body 80D, forms a first contacting portion 734, and another portion of the hemi-spherical surface opposing to the communication passage 84 forms a first pressure receiving portion 737. A remaining half of the hemi-spherical surface on the discharge-port side (on the right-hand side) forms a second pressure receiving portion 72D. A fuel passage 76 is formed between the inner wall surface 633 of the adjusting pipe (the seat member) 63 and the discharge valve body 70D.

The first contacting portion 734 of the discharge valve body 70D is seated on the second seat portion 833 of the relief valve body 80D, when the discharge valve is closed. When the first forward force “FF1” acting on the discharge valve body 70D becomes larger than the second rearward force “FR2” (“FF1”>“FR2”), the discharge valve is opened so that the high pressure fuel in the fuel pressurizing chamber 12 is pumped out from the fuel discharge port 62 via the fuel passages 76.

The relief valve body 80D has the tapered surface portion 833 at the end surface on the discharge-port side, wherein the tapered surface portion 833 forms the second seat portion 833.

The second contacting portion 831 of the relief valve body 80D is seated on the first seat portion 632 of the adjusting pipe 63, when the relief valve is closed. When the second forward force “FF2” acting on the relief valve body 80D, either directly or via the discharge valve body 70D, becomes larger than the first rearward force “FR1” (“FF2”>“FR1”), the relief valve body 80D is moved in the left-hand direction together with the discharge valve body 70D so that the relief valve is opened.

### Sixth Embodiment

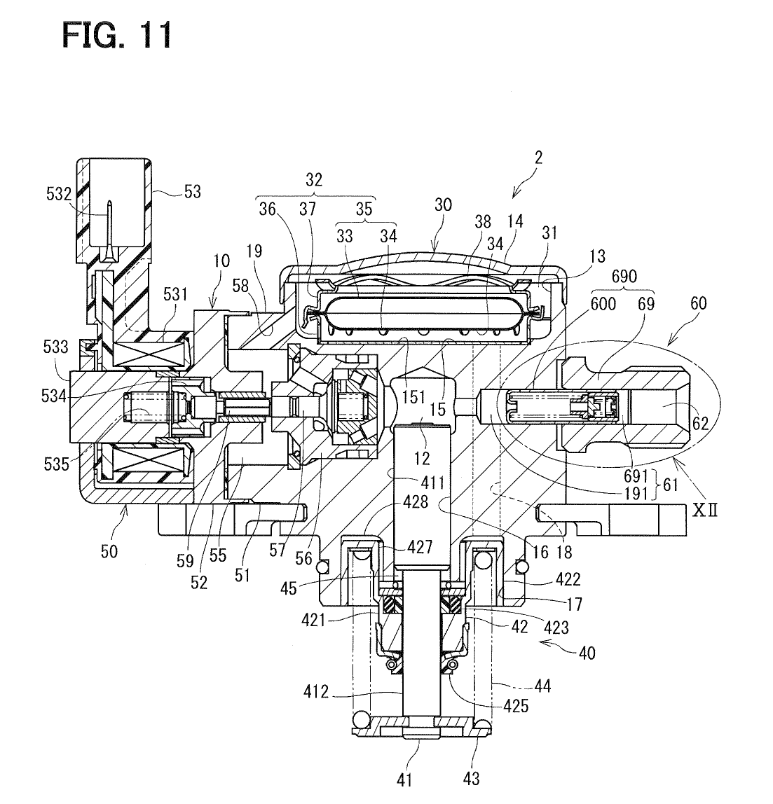

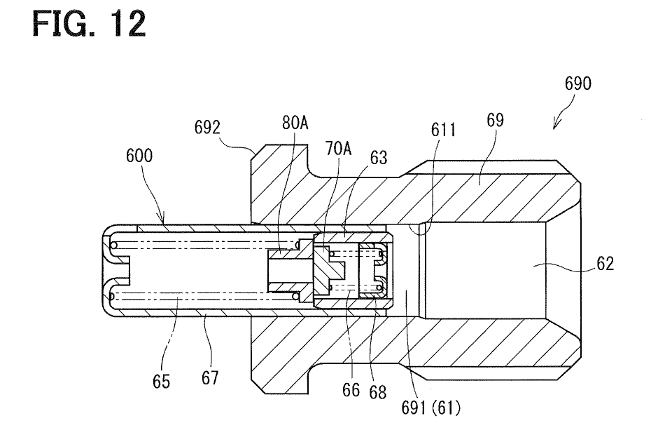

A sixth embodiment will be explained with reference to FIGS. 11 and 12.

According to a high pressure fuel pump 2 of the second embodiment, a discharge-port holder 69 is formed as a separate member from a pump body 19. A first discharge passage 191 communicated to the fuel pressurizing chamber 12 is formed in the pump body 19. A second discharge passage 691 communicated to the discharge port 62 is formed in the discharge-port holder 69. In a condition that the discharge-port holder 69 is fixed to the pump body 19, the first and second discharge passages 191 and 691 form the fuel discharge passage 61.

The pump body 19 and the discharge-port holder 69 form the pump housing.

When manufacturing the high pressure fuel pump 2, a right-hand portion of the discharge-relief valve unit 600 (that is, a portion of the valve unit 600 on a side of the second spring 66) is press inserted into the second discharge passage 691 of the discharge-port holder 69, so as to form a discharge-relief valve module 690 as a sub-assembly component. A step for inspecting and adjusting the relief valve opening pressure may be carried out for the discharge-relief valve unit 600 either before the valve unit 600 will be assembled to the discharge-port holder 69 or after the valve unit 600 has been assembled to the discharge-port holder 69.

A left-hand portion of the discharge-relief valve module 690 (that is, a portion of the valve unit 600 on a side of the first spring 65) is then inserted (for example, press inserted) into the first discharge passage 191 of the pump body 19. A contacting portion 692 of the discharge-port holder 69 is brought into contact with the pump body 19 and firmly fixed to the pump body 19 by welding or the like.

Since the fuel discharge-relief portion 60 (forming the discharge port 62) has a shape outwardly projecting from the pump body, a waste of material may be incurred in the manufacturing process or a specified jig may become necessary in order to avoid interference when setting the product to a manufacturing machine, in a case that the fuel discharge-relief portion 60 is integrally formed with the pump body. According to the present embodiment, the discharge-port holder 69 is formed as the separate member from the pump body so that the manufacturing cost can be reduced.

Although, in the present embodiment, the same structure for the discharge and relief valve bodies to the first embodiment is used, other structure (such as, those of the second to fifth embodiments) maybe applied to the discharge and relief valve bodies.

### Seventh and Eighth Embodiments

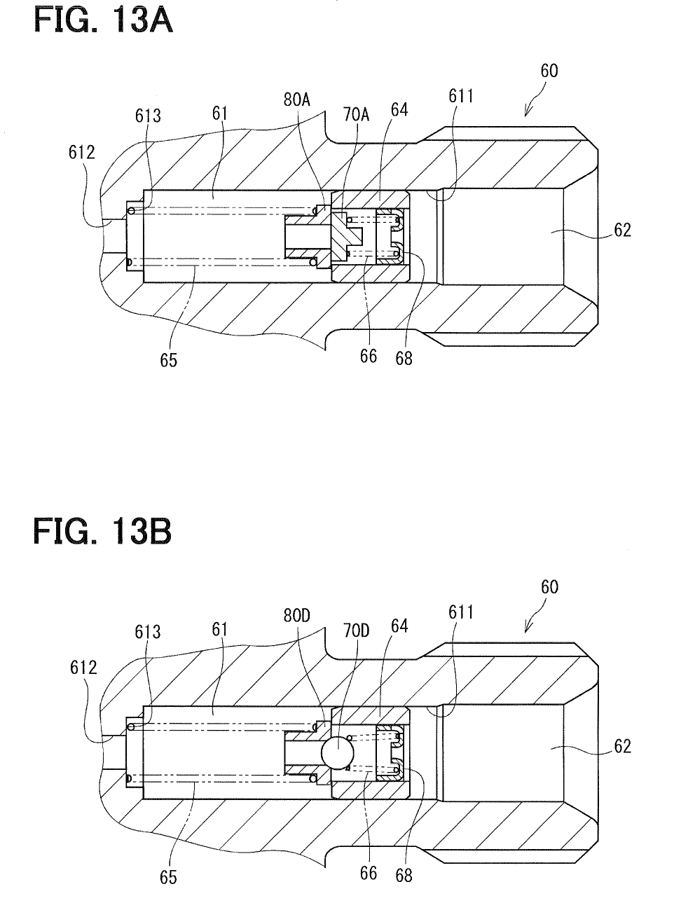

A seventh and an eighth embodiment will be explained with reference to FIGS. 13A and 13B.

According to the seventh and the eighth embodiments, the discharge valve body and the relief valve body are not formed in the sub-assembly component (that is, the discharge-relief valve unit 600) like the first to sixth embodiments. Instead, according to the seventh embodiment, the first spring 65, the relief valve body 80A, the discharge valve body 70A, the second spring 66 and an adjusting pipe (a seat member) 64 are directly assembled in the fuel discharge passage 61 formed in the pump body.

A stepped portion 613 having a smaller diameter (than that of the inner wall 611 of the fuel discharge passage 61) is formed at a bottom of the inner wall 611. A small-diameter passage 612 having a smaller diameter than the stepped portion 613 is formed at a bottom of the stepped portion 613. The stepped portion 613 supports one axial end of the first spring 65, instead of the first spring holder 67 of the first embodiment.

The adjusting pipe (the seat member) 64 is directly press inserted into the inner wall 611 of the fuel discharge passage 61. In the same manner to the above first to sixth embodiments, the second spring holder 68 is press inserted into the inner wall of the adjusting pipe 64. The operation of the present embodiment is substantially the same to the above embodiments.

The structures for the discharge valve body and the relief valve body of the seventh embodiment (FIG. 13A) correspond to (substantially equal to) those of the first embodiment (for example, FIG. 3A), while the structures for the discharge and relief valve bodies of the eighth embodiment (FIG. 13B) correspond to those of the fifth embodiment (FIG. 8B and FIGS. 10A and 10B). However, the structures for the discharge and relief valve bodies may be also made in the structures of the other embodiments (the second to the fourth embodiments).

According to the seventh and eighth embodiments, the advantages of the sub-assembly component can not be obtained. However, in a case of such fuel pumps, for which advantages of the sub-assembly component can not be expected too much, for example, permissible zone for the relief valve opening pressure is relatively large and thereby rate of occurrence of the defective products is extremely small, the seventh or eighth embodiment may become more advantageous in view of a point that the first spring holder 67 is not required in these embodiments.

### Further Modifications

(M-1) According to the above first, second, third, sixth and seventh embodiments, the outer wall portion 711 of the discharge valve body 70A or 70B is formed in the almost cylindrical shape, to thereby form the annular fuel passage 74 between the discharge valve body 70A or 70B and the inner wall 633 of the adjusting pipe 63.

The inner wall 633 guides the sliding movement of the discharge valve body 70A or 70B with a clearance of several mm in the radial direction. It is necessary for the discharge valve body 70A or 70B to form the fuel passage around its outer periphery with a radial clearance, which is almost equal along its circumference. In view of this point, a generally known sliding clearance (which is, for example, less than 0.1 to 0.2 mm in a radial direction) can not be applied to the present embodiments.

Accordingly, as one of modifications, it may be possible to form flat surface portions and/or notched portions at the outer wall portions of the discharge valve body, so that not only the sliding movement of the discharge valve body can be guided by the inner wall 633 of the adjusting pipe 63 but also necessary cross sectional area for the fuel passage can be achieved.

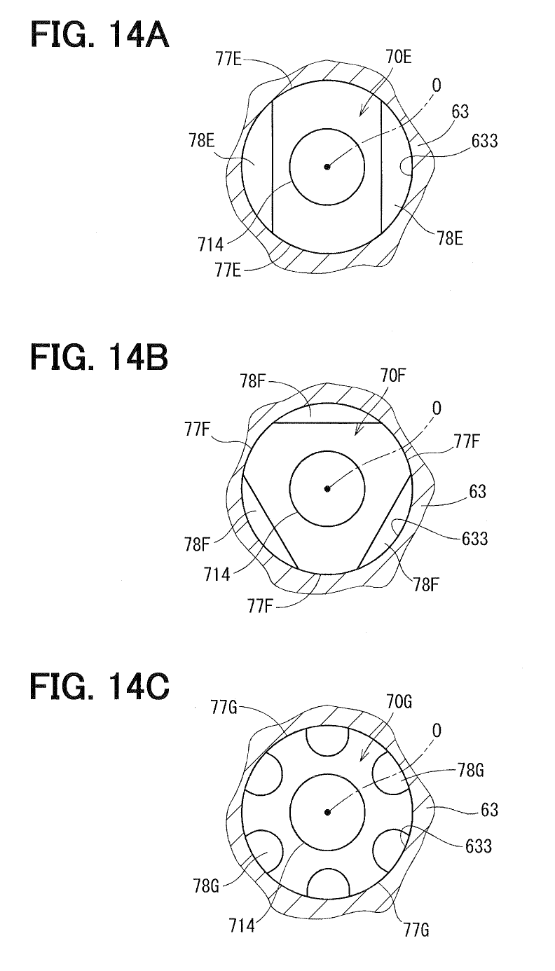

For example, as shown in FIG. 14A, a pair of flat surface portions is formed at the outer wall of a discharge valve body 70E (at two portions in the circumferential direction). According to such a structure, not only sliding surfaces 77E, which are guided by the inner wall 633 of the adjusting pipe 63, are formed, but also the fuel passages 78E are formed.

According to a modification shown in FIG. 14B, three flat surface portions are provided at an outer wall portion of a discharge valve body 70F in the circumferential direction, so as to form three sliding surfaces 77F and three fuel passages 78F.

According to a further modification shown in FIG. 14C, six notched portions are provided at an outer wall portion of a discharge valve body 70G in the circumferential direction, so as to form six sliding surfaces 77G and six fuel passages 78G.

The number of the flat surface portions or the notched portions should not be limited to the above FIGS. 2, 3 or 6.

(M-2) According to the above embodiments, the adjusting pipe (the seat member) 63 is press inserted into the first spring holder 67 or directly into the fuel discharge passage 61 (FIGS. 13A and 13B). And the relief valve opening pressure is controlled by adjusting a press-insert depth of the adjusting pipe 63 into the spring holder or the fuel discharge passage. However, it is not always necessary for the adjusting pipe to have a function of adjusting the press-insert depth. According to a spirit of the present disclosure, it is sufficient that the adjusting pipe has a function for working as the seat member for the first seat portion 632.

(M-3) According to the above embodiments, the second spring holder 68 is press inserted into the adjusting pipe 63 for supporting the second spring 66. A stepped portion may be formed at an inner wall of the adjusting pipe for supporting the one end of the second spring 66, in order to eliminate the second spring holder 68.

In addition, it is not always necessary to provide the notched fuel passages 676 and 686 (FIGS. 3A to 3C) in the first and second spring holders 67 and 68, in a case that a required amount of flow rate can be obtained by the center fuel passages 675 and 685.

(M-4) A process of “press insert” may be replaced by “thermal insert” or “cooling insert”.

(M-5) The structures for the high pressure fuel pump other than the discharge-relief portion should not be limited to those of the above embodiments. For example, the pulsation damper 35 may not be always provided in the fuel chamber 31. The variable volume chamber 45 and the fuel communication passage 18 may not be provided. The suction valve may be not a normally-opened type but a normally-closed type. The cylinder may not be directly formed in the pump body but a separate member is formed as a cylinder member which will be assembled to the pump body.

As above, the present disclosure should not be limited to the above embodiments, but may be modified in various manners without departing the spirit of the disclosure.

What is claimed is:

1. A high pressure fuel pump comprising:
a plunger;
a cylinder for movably accommodating the plunger so that the plunger reciprocates in its axial direction in the cylinder;
a pump housing having; a fuel pressurizing chamber in which fuel is pressurized by a reciprocal movement of the plunger; a fuel discharge port from which high pressure fuel pressurized in the fuel pressurizing chamber is pumped out; and a fuel discharge passage communicating the fuel pressurizing chamber to the fuel discharge port;
a cylindrical seat member provided in the fuel discharge passage and having a first seat portion on an axial end surface of a side to the fuel pressurizing chamber;
a discharge valve body movably accommodated in a radial-inside space of the cylindrical seat member so that the discharge valve body is reciprocated therein in its axial direction,
the discharge valve body having; a first pressure receiving portion at a first axial end thereof on a side to the fuel pressurizing chamber; a first contacting portion at the first axial end in a radial-outside area of the first pressure receiving portion; and a second pressure receiving portion at a second axial end on a side to the fuel discharge port;
a relief valve body movably provided in the fuel discharge passage on a side of the discharge valve body to the fuel pressurizing chamber,
the relief valve body having; a communication passage facing to the first pressure receiving portion and communicating a space of the fuel discharge passage at a first axial end of the relief valve body on a side to the fuel pressurizing chamber with another space of the fuel discharge passage at a second axial end of the relief valve body on a side to the fuel discharge port; a third pressure receiving portion at the first axial end of the relief valve body in a radial-outside area of the communication passage; a second seat portion at the second axial end of the relief valve body in a radial-outside area of the communication passage, wherein the first contacting portion of the discharge valve body is operatively seated on the second seat portion; and a second contacting portion at the second axial end of the relief valve body in a radial-outside area of the second seat portion, wherein the second contacting portion is operatively seated on the first seat portion of the cylindrical seat member;
a first biasing member for biasing the relief valve body in a direction toward the fuel discharge port; and
a second biasing member for biasing the discharge valve body in a direction toward the fuel pressurizing chamber.

2. The high pressure fuel pump according to the claim 1, wherein
an annular fuel passage is formed between an inner wall of the cylindrical seat member and an outer wall portion of the discharge valve body.

3. The high pressure fuel pump according to the claim 1, wherein
the second seat portion and the second contacting portion are formed on an end surface of the second axial end of the relief valve body, wherein the end surface is perpendicular to a center axis of the relief valve body.

4. The high pressure fuel pump according to the claim 3, wherein
the second seat portion and the second contacting portion are formed on the same end surface of the relief valve body to each other.

5. The high pressure fuel pump according to the claim 1, wherein
an axial length of the outer wall portion of the discharge valve body, which is movably inserted into the inner wall of the cylindrical seat member, is larger than a maximum lift amount of the relief valve body.

6. The high pressure fuel pump according to the claim 1, further comprising:
a first holding member for accommodating the first biasing member, the relief valve body, the discharge valve body, and the second biasing member in this order,
wherein the first holding member further accommodates the cylindrical seat member in a radial-outer apace of the discharge valve body and the second biasing member,
wherein the first holding member supports one end of the first biasing member on a side opposite to the relief valve body,
wherein a discharge-relief valve unit is so formed that the first biasing member, the relief valve body, the discharge valve body, the second biasing member and the cylindrical seat member are integrally assembled in the first holding member, and
wherein the discharge-relief valve unit is accommodated in the fuel discharge passage.

7. The high pressure fuel pump according to the claim 6, wherein
a biasing force of the first biasing member can be adjusted when a depth of insertion of the seat member is controlled with respect to the first holding member.

8. The high pressure fuel pump according to the claim 6, wherein
the pump housing comprises;
a pump body having the fuel pressurizing chamber and a first discharge passage communicated to the fuel pressurizing chamber; and
a discharge-port holder fixed to the pump body and having the fuel discharge port and a second discharge passage communicated to the first discharge passage,
wherein an end of the discharge-relief valve unit on a side of the second biasing member is accommodated in the second discharge passage, to thereby form a discharge-relief valve module, and
wherein the other end of the discharge-relief valve unit on a side of the first biasing member is accommodated in the first discharge passage of the pump body.
